(19) United States
(12) Patent Application Publication
(10) Pub. No.: US 2015/0257975 A1
(43) Pub. Date: Sep. 17, 2015

(54) CONTAINER FOR MEDICAL IV BAG

(71) Applicant: Elia Sung, Mundelein, IL (US)

(72) Inventor: Elia Sung, Mundelein, IL (US)

(21) Appl. No.: 14/203,907

(22) Filed: Mar. 11, 2014

(51) Int. Cl. A61J 1/10; B65D 17/00; B65D 33/04; A61J 1/14; B65D 25/04

(52) U.S. Cl. CPC A61J 1/10; A61J 1/1475; B65D 25/04; B65D 33/04; B65D 17/20; A61J 2205/50; B65D 2517/0031

(57) ABSTRACT

A container for transporting an intravenous (IV) bag containing a hazardous substance, such as a chemotherapy drug, includes first and second sidewalls sealed together about a periphery to form an interior having first and second inner compartments, and a third sidewall sealed to a sidewall to form an outer compartment. The container may include features such as a tear strip along a portion of the sealed bottom edge, an access port to the first inner compartment located in at least one of the sidewalls, and biohazard labeling on an outer surface. The first inner compartment and the second inner compartment are contoured for retaining an IV bag and the associated port tubing in a usable position within the container, while the sidewalls are made of a transparent flexible material, and/or partly of a polymer material and partly of a paper material.

### TECHNICAL FIELD OF THE INVENTION

The present invention relates to containers for transport of IV bags containing hazardous substances, such as chemotherapy agents and the like. Specifically, the present invention relates to flexible containers for loading, transporting and disposing of such IV bags and the hazardous substances they may contain.

### BACKGROUND OF THE INVENTION

Every day in almost every hospital and treatment facility across the United States, health care workers and patients are needlessly exposed to potentially harmful drugs. Exposure to some drugs has the potential for carcinogenicity, genotoxicity, fetal toxicity, mutagenicity, as well as other serious health effects. The safety of these workers and patients has been a primary focus of several organizations over the last few decades. For example, more than 20 years ago the American Society of Health-System Pharmacists (ASHP) published a technical assistance bulletin (TAB) on handling cytotoxic and hazardous drugs. In 1995, continued reports of workplace contamination and concerns for health care worker safety prompted the Occupational Safety and Health Administration (OSHA) to issue new guidelines on controlling occupational exposure to hazardous drugs. In 2004, the National Institute for Occupational Safety and Health (NIOSH) issued the “NIOSH Alert: Preventing Occupational Exposure to Antineoplastic and Other Hazardous Drugs in Health Care Settings.” These reports and guidelines do not go far enough to address hazardous drug exposure to health care workers and patients. Additional personal protective equipment (PPE) is needed for hazardous substance handling best practices to improve patient and health care worker safety.

One identified problem with current devices and systems is the manner in which such hazardous substances are packaged in a safe lab environment and transported to a patient's bedside for administration. Typically, the hazardous substance, which is loaded into a special marked IV bag by skilled and properly protected clinicians, is haphazardly placed within a non-descript, opaque container with all the required port tubing, patient prep materials and instructions for administering and disposal. Bending, folding, sharp edges, faulty equipment and carelessness can easily lead to leaks. Vaporization of hazardous substances is also a risk faced using current materials and practices. Further, if a leak or vaporization exists or is created during transport, it may not be discovered until reaching the patient's bedside, or worse, during administering of the drug to the patient. Opaque packaging, even just on one side, diminishes the ability of a worker to easily see what is inside.

Another identified problem in the industry relates to administering of the hazardous material at the bedside. Once a container of hazardous drugs and associated port tubing and prep materials reaches the patient, a health care worker has to remove the contents from the transport bag in order to hang the IV bag. Immediately the patient and health care worker are exposed to hazardous substances leaking from the IV bag, including future leaks which may occur. That is, once removed the container is no longer able to provide containment of material from a leak. Further, with the removal of the transport container, any residual hazardous material on the inner surfaces, the IV bag or associated tubing provides additional sources for exposure to workers, patients and anyone else who may come into contact with such sources.

Still another problem with prior devices and systems is the potential for contamination of the drug itself. After an IV bag leaves the sterile preparation environment (e.g., a compounding hood), it may be exposed to countless external pathogens, such as bacteria. Even in a standard container, exposure to pathogens is significant.

Finally, assuming transporting and administering of the hazardous drug is performed safely and without incident, there is the issue of disposing of any remaining drug, as well as the IV bag and tubing. Typically, a second container is used to place the hazardous assembly within for disposal. The use of two plastic containers for each IV bag administered to a patient (not including the IV bag itself) is neither an economically or ecologically sound practice.

Until the invention of the present application, these and other problems in the prior art went either unnoticed or unsolved by those skilled in the art. The present invention provides a closed system delivery container for IV bags and associated tubing and supplies which performs multiple functions, including contamination and exposure protection, leak containment, improved viewability, as well as a customized, eco-friendly delivery, administering and disposal unit for hazardous drugs and a related assembly without sacrificing affordability.

### SUMMARY OF THE INVENTION

There is disclosed herein an improved container for an intravenous (IV), intra-arterial and intra-peritoneal bag and related accessories, which avoids the disadvantages of prior devices and systems while affording additional structural and operating advantages.

Generally speaking, the disclosed invention is a container for transporting an intravenous (IV) bag containing a hazardous substance, such as a chemotherapy drug. In general, the container comprises a first sidewall and a second sidewall sealed together about the periphery to form an interior comprised of first and second inner compartments, and a third sidewall sealed to the sidewalls of one of either the first sidewall and the second sidewall to form an outer compartment.

In specific embodiments, the container may further comprise features including a tear strip along at least a portion of the sealed bottom edges of the first and second sidewalls, an access port to the first inner compartment located in at least one of the first sidewall and the second sidewall, and biohazard labeling on an outer surface of the first sidewall and an outer surface of the second sidewall.

In certain embodiments of the container, the access port comprises an area in at least one of the sidewalls defined by a perforation, the first inner compartment and the second inner compartment are contoured for retaining an IV bag and the associated port tubing in a usable position within the container, the sidewalls are comprised of a transparent flexible material, and/or the sidewalls are comprised partially of a polymer material and partly of a paper material.

In a preferred embodiment, the container for transporting an intravenous (IV) bag containing a hazardous substance is comprised of first and second flexible sidewall panels sealed together along an outer periphery to form a pouch having first and second inner compartments defined therein and configured to retain an IV bag and associated port tubing in a usable position with the compartments, and a third flexible sidewall panel sealed to an outer surface of the pouch to define an outer compartment.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings, embodiments thereof, from an inspection of which, when considered in connection with the following description, the subject matter sought to be protected, its construction and operation, and many of its advantages should be readily understood and appreciated.

FIG. 1 is a front view of an embodiment of the disclosed container;

FIG. 2 is an illustration of an embodiment of the disclosed container in use;

FIG. 3 is a partial illustration of a back side of an embodiment of the disclosed container;

FIGS. 4-6 illustrate an embodiment of the rear compartment of the disclosed container; and

FIGS. 7A-7C illustrate an embodiment of the disclosed container having a tear strip to access the inner compartments.

### DETAILED DESCRIPTION OF THE INVENTION

While this invention is susceptible of embodiments in many different forms, there is shown in the drawings and will herein be described in detail at least one preferred embodiment of the invention with the understanding that the present disclosure is to be considered as an exemplification of the principles of the invention and is not intended to limit the broad aspect of the invention to any of the specific embodiments illustrated.

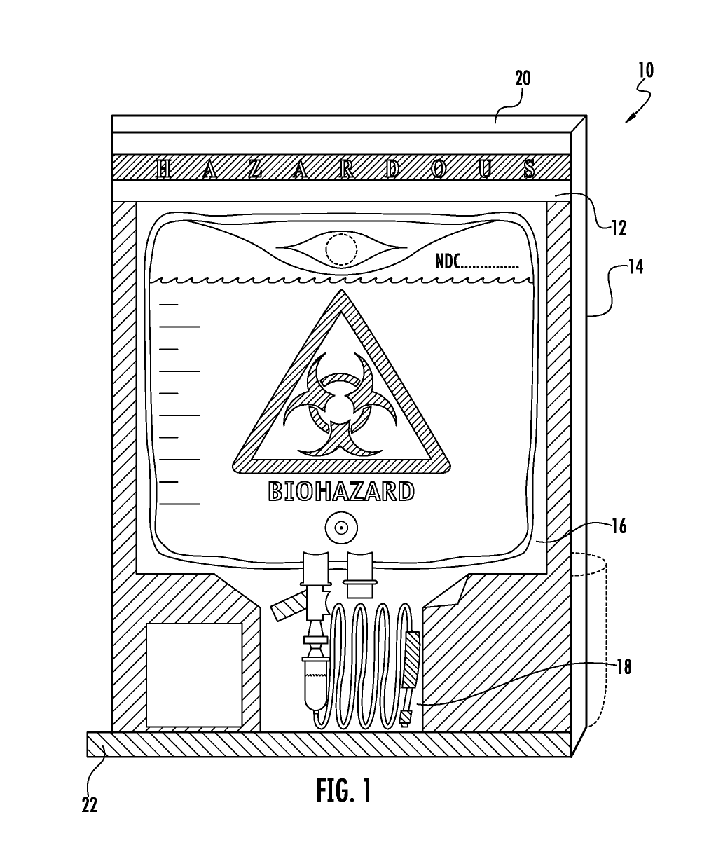

Referring to FIGS. 1-7, there is illustrated a container for retaining an IV bag, generally designated by the numeral 10. The particular illustrated container 10 is for retaining an IV bag containing a hazardous substance, such as a chemotherapy drug, and all the related and necessary tubing, for safe transportation, usage and disposal of the IV bag and materials. However, it should be understood that the principles of the invention can be applied to use with intra-arterial and intra-peritoneal bags as well as with non-hazardous IV bags used for administering, for example, antibiotics, blood, parenteral nutrition, and the like.

As can be seen in FIG. 1, the container 10 is comprised of first and second sidewall panels, 12 and 14, sealed together along the left, right and bottom edges. The contoured sealing of the panels together forms a first or upper compartment 16 and a second or lower compartment 18. The top edge 20 of the container 10 is open, but includes a dual-sided hazardous zipper seal or a comparable reusable seal. Along each side edge, the seal is preferably the result of multiple seals to provide sufficient support of a full IV bag and all necessary accessories. As shown, the sealing width is different along the first compartment than along the second compartment. Preferably, the seal width along each side edge of the first compartment 16 is between approximately 0.25 to 1.25 inches (about 0.64 to 3.18 cm), while the width along each side of the second compartment 18 is in the range of approximately 1.50 to 3.5 inches (about 3.81 to 8.89 cm). Of course, a greater or lesser sealing width is possible where the edges are reinforced to prevent any possible separation of the sidewall panels.

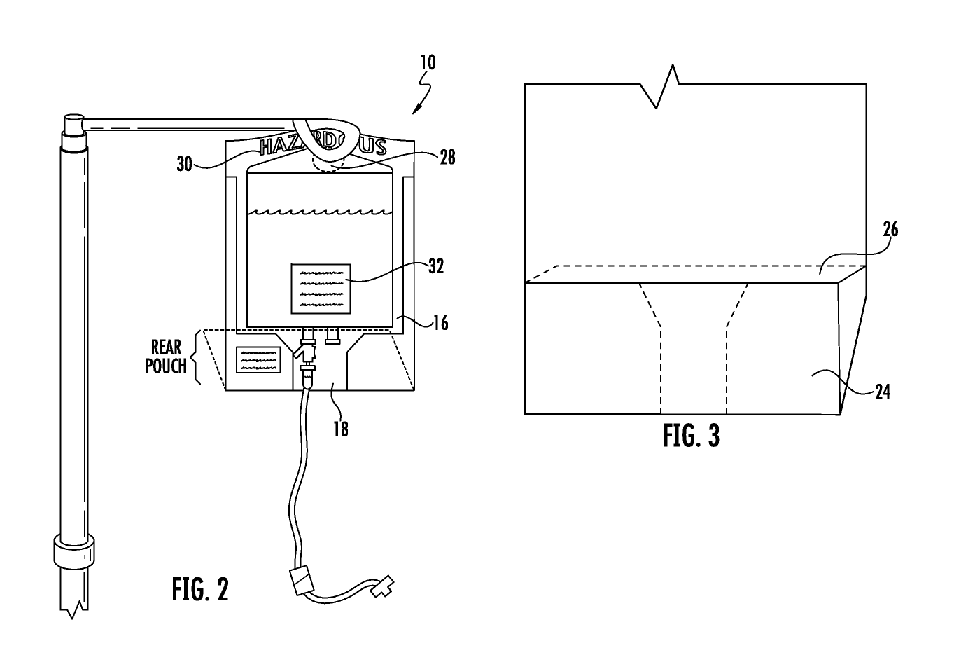

The bottom edge of the container 10 is also preferably heat-sealed, having a width in the range of from about 0.50 to 1.0 inches (about 1.27 to 2.54 cm), but also includes a tear-strip 22 to provide access to the second compartment 18. That is, once the tear-strip 22 is removed, the second compartment 18 is open at the bottom edge (e.g., see FIG. 2).

As shown best in FIG. 3, a third panel 24 is sealed to the container 10 along the side and bottom edges to form an outer pouch 26 which is open at its top edge. The use of the pouch 26 will be explained in greater detail below.

Another preferred feature of the container 10 includes a perforated port 28 on at least one, but preferably both, side panels, 12 and 14. As shown in FIG. 2, the port 28 allows access to the IV bag to be hung on an IV pole. Indicia 30 and “instructions” 32 are also prominently displayed on at least one of the panels 12 and 14. The indicia 30 may include words (e.g., HAZARDOUS), symbols, and/or colors to provide warning to others. The “instructions” 32 may be directed to advising a user as to handling, disposal, exposure treatment, and/or other such important details.

The side panels 12 and 14 are most preferably made from a flexible, clear plastic material, including PVC and non-PVC materials. The thickness of the sidewall panels 12, 14, and the pouch 26, preferably falls within a range of from about 3 to about 8 mil (0.003 to 0.008 inch), but may have greater thicknesses for some applications. With both panels, 12 and 14, being clear, the ability to see all sides of the enclosed IV bag is enhanced and provides a safety feature for handlers. For example, the back of the IV bag having a medication label is readable by the health care provider to view pertinent information, such as dose, infusion time, etc. Further, as the container 10 is not intended to directly contact the hazardous contents of the IV bag, the container 10 may be manufactured of materials not approved for IV bags. In an alternative embodiment, the container 10 is comprised of both a plastic material and a paper material. The plastic/paper embodiment may be particularly useful with non-vesicant substances. The plastic/paper configuration uses less plastic which provides eco-friendly advantages, cost savings, and greater handling and disposal options.

When warranted, the use of inner UV and aluminum lining inserts can be employed. These inserts are intended to accommodate hazardous substances that require protection from light (e.g., oxaliplatin) and temperature regulation (e.g., cisplatin used in heated intraperitoneal chemotherapy procedures (HIPEC)).

In use, the container 10 is first opened along the zipper lock at top edge 20. While within a safe environment (e.g., a compounding hood), a prepared IV bag and the associated tubing, valves and accessories are placed into the container 10. First, the associated tubing, valves and accessories are placed into the second/lower compartment 18, then the IV bag is placed into the first/upper compartment 16. The zipper lock is then sealed tight for transport to a patient's bedside.

Additional accessories, such as swabs, prep pads, connectors, luer locks, drug information, latex gloves, etc., may be loaded into the outer pouch 26.

Once at the patient's bedside, the container 10 can be visually inspected for any IV bag leaks. If any liquid is noted within the container 10, proper disposal/handling protocol can be followed. This prevents hazardous substance exposure to healthcare workers and patients. If the IV bag passes the visual inspection, the IV bag label can be read and checked through the container 10 without removal.

Continuing, the perforated access port 28 may be opened to provide access to the IV bag hanging aperture. The IV bag, still within the container 10, is then attached to an IV pole as shown in FIG. 2.

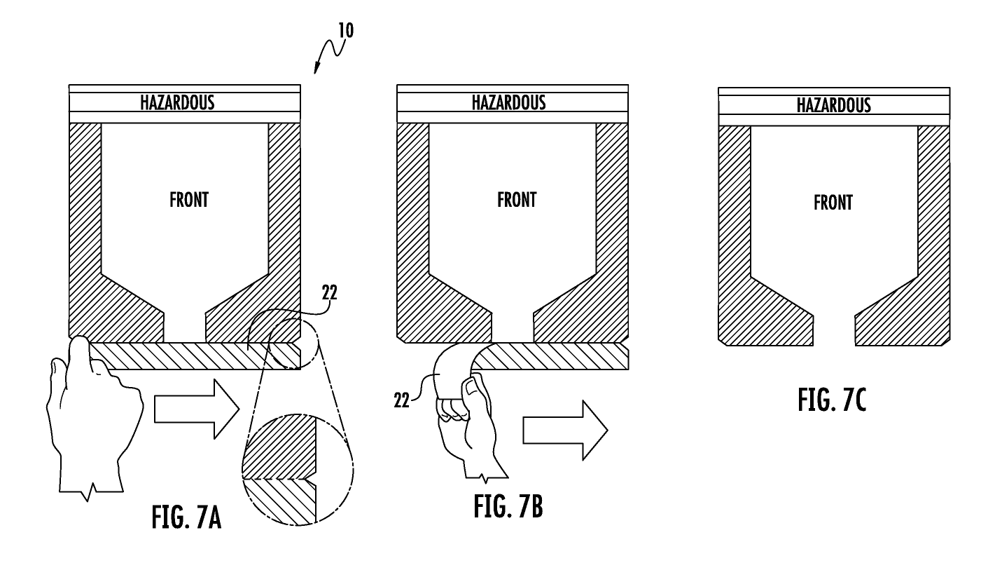

From this position, as illustrated in FIGS. 7A-7C, the tear-strip 22 along the container bottom edge is then removed to provide access to the stored tubing and accessories. Once freed from the second compartment 18, the IV tubing and accessories may be used to connect the IV bag to the patient.

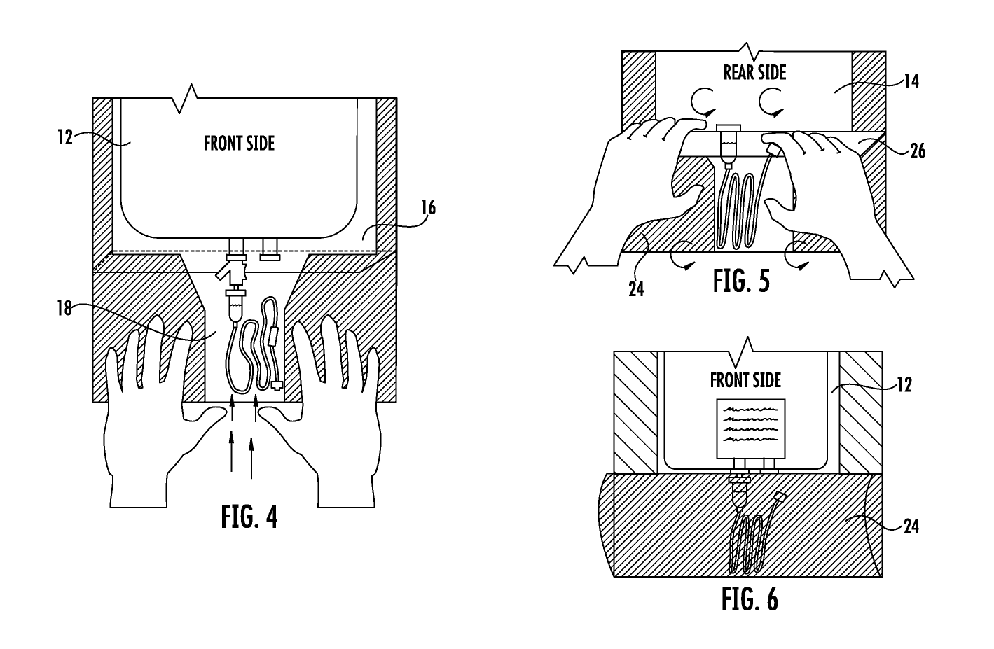

Finally, upon completing the administration of the IV to the patient, the tubing and accessories are to be disconnected. Referring to FIGS. 4-6, the accessories and tubing are carefully reinserted into the second compartment 18 through the open bottom. The rear outer pouch 26 is then folded forward, under the open bottom to effectively close off the bottom. The IV bag is then to be removed from the IV pole and the entire container, including the enclosed IV bag and accessories, is properly discarded. A second hazardous waste disposal bag is not necessary, as the container 10 includes all the required indicia to be used for disposal.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A container for transporting an intravenous (IV) bag containing a hazardous substance, the container comprising:
a first sidewall having two opposing side edges, a top edge and a bottom edge;
a second sidewall having two opposing side edges, a top edge and a bottom edge;
a first inner compartment defined by at least a portion of the first and second sidewalls, wherein each of the side edges of the second sidewall is sealed to a side edge of the first sidewall, and the top edge of the second sidewall is releasably sealed to the top edge of the first sidewall;
a second inner compartment defined by at least a portion of the first and second sidewalls and a side of the first inner compartment, wherein each of the side edges of the second sidewall is sealed to a side edge of the first sidewall, and the bottom edge of the second sidewall is sealed to the bottom edge of the first sidewall;
a third sidewall having two opposing side edges, a top edge and a bottom edge; and
an outer compartment defined by the side edges of the third sidewall being sealed to the sidewalls of one of either the first sidewall and the second sidewall, and the bottom edge being sealed to the bottom edge of one of either the first sidewall and the second sidewall.

2. The container of claim 1, further comprising a tear strip along at least a portion of the sealed bottom edges of the first and second sidewalls.

3. The container of claim 1, further comprising an access port to the first inner compartment located in at least one of the first sidewall and the second sidewall.

4. The container of claim 1, wherein the first sidewall and the second sidewall are transparent.

5. The container of claim 1, wherein the first and second inner compartments each has a volume and the volume of the first compartment is greater than the volume of the second compartment.

6. The container of claim 5, wherein the first inner compartment is coupled to the second inner compartment.

7. The container of claim 1, wherein the outer compartment is configured to fold under the bottom edge of the first and second sidewall.

8. The container of claim 1, further comprising biohazard labeling on an outer surface of the first sidewall and an outer surface of the second sidewall.

9. The container of claim 2, wherein removal of the tear strip provides access to the second inner compartment.

10. The container of claim 3, wherein the access port comprises an area in at least one of the sidewalls defined by a perforation.

11. The container of claim 1, wherein the first inner compartment and the second inner compartment are contoured for retaining an IV bag and the associated port tubing in a usable position within the container.

12. The container of claim 1, wherein the first sidewall, second sidewall and third sidewall are comprised of a flexible material.

13. The container of claim 12, wherein the flexible material comprises a polymer.

14. The container of claim 13, wherein the flexible material further comprises a fibrous material.

15. A container for transporting an intravenous (IV) bag containing a hazardous substance, the container comprising:
first and second flexible sidewall panels sealed together along an outer periphery to form a pouch having first and second inner compartments defined therein and configured to retain an IV bag and associated port tubing in a usable position with the compartments; and
a third flexible sidewall panel sealed to an outer surface of the pouch to define an outer compartment.

16. The container of claim 15, further comprising a tear strip along at least a portion of a sealed bottom edge of the first and second sidewalls.

17. The container of claim 16, further comprising a resealable opening between the first and second sidewalls along a top edge.

18. The container of claim 15, further comprising an access port to the first inner compartment located in at least one of the first sidewall and the second sidewall.

19. The container of claim 15, wherein the first sidewall and the second sidewall are transparent.

20. The container of claim 15, wherein the first sidewall, second sidewall and third sidewall are comprised of at least one of a polymer and a fibrous material.
